(19) United States
(12) Patent Application Publication
(10) Pub. No.: US 2015/0299540 A1
(43) Pub. Date: Oct. 22, 2015

(54) SPECIFIC AMINOALKYL-FUNCTIONAL ALKOXYSILOXANE OLIGOMER MIXTURES, PROCESS FOR PRODUCTION THEREOF AND USE THEREOF

(71) Applicants: Thomas SCHLOSSER, Inzlingen (DE); Ingo KIEFER, (US); Juergen FRITZ, (US); Regina KRAUSE, Rheinfelden (DE); Svenja SCHUETT, (US)

(72) Inventors: Thomas Schlosser, Inzlingen (DE); Ingo Kiefer, Schopfheim (DE); Juergen Fritz, Grenzach-Wyhlen (DE); Regina Krause, Rheinfelden (DE); Svenja Schuett, Loerrach (DE)

(73) Assignee: EVONIK INDUSTRIES AG, Essen (DE)

(21) Appl. No.: 14/646,530

(22) PCT Filed: Sep. 25, 2013
(86) PCT No.: PCT/EP2013/069987

§ 371 Date: May 21, 2015

(30) Foreign Application Priority Data
Nov. 22, 2012 (DE) 10 2012 221 379.1

(51) Int. Cl. C09J 175/04

(52) U.S. Cl. CPC C09J 175/04

(57) ABSTRACT

The present invention relates to specific mixtures comprising catenated aminopropyl-functional alkoxysiloxanes of the general formula I and/or cyclic aminopropyl-functional alkoxysiloxanes of the general formula II

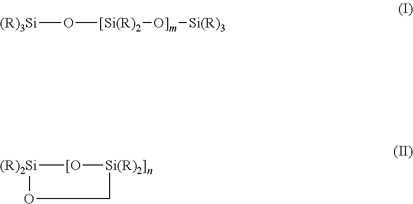

in which the R groups independently consist of
(i) aminopropyl-functional groups of the formula

—(CH₂)₃—NH₂,—(CH₂)₃—NH(CH₂)₂—NH₂ and/or —(CH₂)₃—NH(CH₂)₂—NH(CH₂)₂—NH₂,
(ii) methoxy and/or ethoxy groups and
(iii) optionally butyl or octyl groups,
m is an integer from 2 to 30 and n is an integer from 3 to 30, where not more than one aminoalkyl-functional group is bonded to any silicon atom in a compound of the formula I and/or II, and
where the quotient of the molar ratio of Si to alkoxy groups is at least 0.3, and to a process for production thereof. These are of excellent suitability for application in adhesives and sealants and are notable here for improved bonding, especially on substrates that are difficult to bond to one another.

The present invention relates to specific aminoalkyl-functional alkoxysiloxane oligomer mixtures, to a process for production thereof and to the use thereof in adhesives and sealants.

Monomeric organofunctional silanes have been used successfully for many years to formulate adhesives and sealants. Especially in moisture-crosslinking adhesives and sealants, called reactive adhesives and sealants, for example in silicones or in (alkoxysilane-)terminated polymers such as polyurethanes or polyethers, amino-functional alkoxysilanes have been found to be efficient bonding agents. Examples of hotmelt adhesives or sealants which postcrosslink under the action of moisture, cure via terminal isocyanate and/or alkoxysilane groups and contain polymers functionalized with aminosilanes can be found in DE 38 40 220 A1. When amino-functional alkoxysilanes are used as bonding agent, it is possible to improve the adhesion to the substrate to be bonded/sealed. At the same time, cohesion within the adhesive and sealant is also increased. For the sealing/bonding of substrates that are generally difficult to seal or difficult to bond, for example aluminium and plastics, for example polymethylmethacrylate (“PMMA”) and polycarbonate (“PC”), amino-functional alkoxysilanes used as standard, for example aminopropyltrimethoxysilane (Dynasylan® AMMO), usually give only basic adhesion. Therefore, it is necessary in various applications to work (in a preparatory step) with primers.

EP 0 997 469 A2 and EP 1 304 345 A2 give a general disclosure of aminoalkylalkoxysiloxane-containing mixtures. Thus, EP 0 997 469 A2 discloses two specific examples of a 3-aminopropyl/n-propyl/methoxysiloxane oligomer mixture and an N-aminoethyl-3-aminopropyl/n-propyl/methoxysiloxane oligomer mixture, and EP 1 304 345 A2 discloses the specific examples proceeding from tetraethoxysilane and aminopropyltrimethoxysilane; tetraethoxysilane, propyltriethoxysilane and aminopropyltrimethoxysilane; methyltrimethoxysilane, propyltrimethoxysilane and N-aminoethyl-3-aminopropyltriethoxysilane; propyltrimethoxysilane and N-(n-butyl)-2-aminopropyltrimethoxysilane; methyltriethoxysilane, propyltriethoxysilane and aminopropyltrimethoxysilane; phenyltrimethoxysilane, propyltrimethoxysilane and aminopropyltrimethoxysilane, and vinyltrimethoxysilane, propyltrimethoxysilane and aminopropyltrimethoxysilane.

The problem addressed by the present invention is that of providing an additive for compositions which can be used especially as adhesives and sealants, which are easy to use and to measure out, and which give bonds and seals having distinctly improved adhesion to a wide variety of different substrates, for example to metals and plastics.

It has been found that, surprisingly, the use of a mixture based on specific aminopropyl-functional alkoxysiloxane oligomers, as disclosed especially by claims 1, 7 and 10, in combination with silane-modified polymers, advantageously leads to an improvement in adhesion in bonds of moisture-crosslinking adhesives and sealants, for example of silicones or of silane-modified polyurethanes or of silane-modified polyethers, to a wide variety of different substrates, for example to aluminium surfaces or plastic surfaces.

The present invention thus relates to a mixture at least comprising catenated aminopropyl-functional alkoxysiloxanes of the general formula I and/or cyclic aminopropyl-functional alkoxysiloxanes of the general formula II

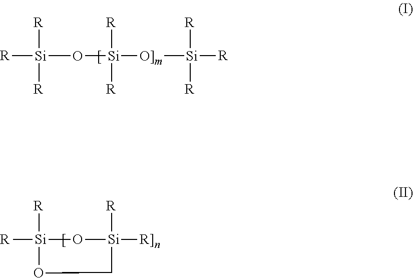

in which the R groups independently consist of
(i) aminopropyl-functional groups of the formulae

—(CH₂)₃—NH₂, —(CH₂)₃—NH(CH₂)₂—NH₂ and/or —(CH₂)₃—NH(CH₂)₂—NH(CH₂)₂—NH₂,

(ii) methoxy and/or ethoxy groups and
(iii) optionally butyl or octyl groups,
m is an integer from 2 to 30 and n is an integer from 3 to 30,
where not more than one aminopropyl-functional group is bonded to any silicon atom in a compound of the formula I or II, and
where the quotient of the molar ratio of Si to alkoxy groups is at least 0.3, preferably ≧0.4, especially ≧0.5.

Preferably, the individual R groups in the compounds of the formulae I and II are each independently selected from the group of the 3-aminopropyl, N-(2-aminoethyl)-3-aminopropyl, N—[N′-(2-aminoethyl)-2-aminoethyl]-3-aminopropyl, methoxy, ethoxy, i-butyl, n-butyl, i-octyl, n-octyl radicals.

More particularly, inventive mixtures are characterized in that the individual R groups in the compounds of the formulae I and II in a mixture of the aminopropyl-functional alkoxysiloxane oligomers are the radicals
3-aminopropyl and methoxy,
3-aminopropyl and ethoxy,
N-(2-aminoethyl)-3-aminopropyl and methoxy,
N-(2-aminoethyl)-3-aminopropyl and ethoxy,
N—[N′-(2-aminoethyl)-2-aminoethyl]-3-aminopropyl and methoxy,
N—[N′-(2-aminoethyl)-2-aminoethyl]-3-aminopropyl and ethoxy,
3-aminopropyl, i-butyl and methoxy,
3-aminopropyl, i-butyl and ethoxy,
N-(2-aminoethyl)-3-aminopropyl, i-butyl and methoxy,
N-(2-aminoethyl)-3-aminopropyl, i-butyl and ethoxy,
N—[N′-(2-aminoethyl)-2-aminoethyl]-3-aminopropyl, i-butyl and methoxy,
N—[N′-(2-aminoethyl)-2-aminoethyl]-3-aminopropyl, i-butyl and ethoxy,
3-aminopropyl, n-butyl and methoxy,
3-aminopropyl, n-butyl and ethoxy,
N-(2-aminoethyl)-3-aminopropyl, n-butyl and methoxy,
N-(2-aminoethyl)-3-aminopropyl, n-butyl and ethoxy,
N—[N′-(2-aminoethyl)-2-aminoethyl]-3-aminopropyl, n-butyl and methoxy,
N—[N′-(2-aminoethyl)-2-aminoethyl]-3-aminopropyl, n-butyl and ethoxy,
3-aminopropyl, i-octyl and methoxy,
3-aminopropyl, i-octyl and ethoxy,
N-(2-aminoethyl)-3-aminopropyl, i-octyl and methoxy,
N-(2-aminoethyl)-3-aminopropyl, i-octyl and ethoxy,
N—[N′-(2-aminoethyl)-2-aminoethyl]-3-aminopropyl, i-octyl and methoxy,
N—[N′-(2-aminoethyl)-2-aminoethyl]-3-aminopropyl, i-octyl and ethoxy,
3-aminopropyl, n-octyl and methoxy,
3-aminopropyl, n-octyl and ethoxy,
N-(2-aminoethyl)-3-aminopropyl, n-octyl and methoxy,
N-(2-aminoethyl)-3-aminopropyl, n-octyl and ethoxy,
N—[N′-(2-aminoethyl)-2-aminoethyl]-3-aminopropyl, n-octyl and methoxy or
N—[N′-(2-aminoethyl)-2-aminoethyl]-3-aminopropyl, n-octyl and ethoxy.

In addition, inventive mixtures comprising catenated aminopropyl-functional alkoxysiloxanes of the general formula I and/or cyclic aminopropyl-functional alkoxysiloxanes of the general formula II advantageously have a boiling point at pressure 1 atm of greater than 200° C.

Furthermore, inventive mixtures comprising catenated aminopropyl-functional alkoxysiloxanes of the general formula I and/or cyclic aminopropyl-functional alkoxysiloxanes of the general formula II have a flashpoint of greater than 100° C.

Inventive mixtures are based essentially on catenated aminopropyl-functional alkoxysiloxanes of the formula I and/or cyclic aminopropyl-functional alkoxysiloxanes of the general formula II, where the content of alkoxy groups is preferably between 0.1% and 70% by weight, more preferably 0.5% to 60% by weight and most preferably 5% to 50% by weight, and the content of free alcohol in the mixture, especially methanol and/or ethanol, is <5% by weight, preferably 0.001% to 3% by weight, more preferably 0.01% to 1% by weight, based on the weight of the aminopropyl-functional alkoxysiloxane oligomer mixture.

The present invention further provides a process for producing a mixture which is characterized in that
as component A at least one 3-aminopropyl-functional trialkoxysilane, at least one N-(2-aminoethyl)-3-aminopropyl-functional trialkoxysilane and/or at least one N-[N′-(2-aminoethyl)-2-aminoethyl]-3-aminopropyltrialkoxysilane and optionally, as component B, at least one butyltrialkoxysilane or an octyltrialkoxysilane are used, where alkoxy in each case is methoxy or ethoxy,
components A and optionally B, successively or in a mixture, are subjected to controlled hydrolysis and condensation or co-condensation at a temperature of 60 to 80° C., using 0.7 to 1.2 mol of water per 1 mol of Si and 0.1 to 0.5 times the weight of methanol and/or ethanol, based on the alkoxysilanes used, and
the alcohol used and the alcohol released in the reaction from the product mixture are subsequently removed by distillation at standard pressure or under reduced pressure and a bottom temperature up to 90° C.

Preference is given to using, as components A and optionally B in the process according to the invention,
3-aminopropyltrimethoxysilane (AMMO),
3-aminopropyltriethoxysilane (AMEO),
N-(2-aminoethyl)-3-aminopropyltrimethoxysilane (DAMO),
N-(2-aminoethyl)-3-aminopropyltriethoxysilane (DAEO),
N—[N′-(2-aminoethyl)-2-aminoethyl]-3-aminopropyltrimethoxysilane (TRIAMO),
N—[N′-(2-aminoethyl)-2-aminoethyl]-3-aminopropyltriethoxysilane,
3-aminopropyltrimethoxysilane and i-butyltrimethoxysilane (IBTMO),
3-aminopropyltriethoxysilane and i-butyltriethoxysilane (IBTEO),
N-(2-aminoethyl)-3-aminopropyltrimethoxysilane and i-butyltrimethoxysilane,
N-(2-aminoethyl)-3-aminopropyltriethoxysilane and i-butyltriethoxysilane,
N—[N′-(2-aminoethyl)-2-aminoethyl]-3-aminopropyltrimethoxysilane and i-butyltrimethoxysilane,
N—[N′-(2-aminoethyl)-2-aminoethyl]-3-aminopropyltriethoxysilane and i-butyltriethoxysilane,
3-aminopropyltrimethoxysilane and n-butyltrimethoxysilane,
3-aminopropyltriethoxysilane and n-butyltriethoxysilane,
N-(2-aminoethyl)-3-aminopropyltrimethoxysilane and n-butyltrimethoxysilane,
N-(2-aminoethyl)-3-aminopropyltriethoxysilane and n-butyltriethoxysilane,
N—[N′-(2-aminoethyl)-2-aminoethyl]-3-aminopropyltrimethoxysilane and n-butyltrimethoxysilane,
N—[N′-(2-aminoethyl)-2-aminoethyl]-3-aminopropyltriethoxysilane and n-butyltriethoxysilane,
3-aminopropyltrimethoxysilane and i-octyltrimethoxysilane (OCTMO),
3-aminopropyltriethoxysilane and i-octyltriethoxysilane (OCTEO),
N-(2-aminoethyl)-3-aminopropyltrimethoxysilane and i-octyltrimethoxysilane,
N-(2-aminoethyl)-3-aminopropyltriethoxysilane and i-octyltriethoxysilane,
N—[N′-(2-aminoethyl)-2-aminoethyl]-3-aminopropyltrimethoxysilane and i-octyltrimethoxysilane,
N—[N′-(2-aminoethyl)-2-aminoethyl]-3-aminopropyltriethoxysilane and i-octyltriethoxysilane,
3-aminopropyltrimethoxysilane and n-octyltrimethoxysilane (OCTMO),
3-aminopropyltriethoxysilane and n-octyltriethoxysilane (OCTEO),
N-(2-aminoethyl)-3-aminopropyltrimethoxysilane and n-octyltrimethoxysilane,
N-(2-aminoethyl)-3-aminopropyltriethoxysilane and n-octyltriethoxysilane,
N—[N′-(2-aminoethyl)-2-aminoethyl]-3-aminopropyltrimethoxysilane and n-octyltrimethoxysilane or
N—[N′-(2-aminoethyl)-2-aminoethyl]-3-aminopropyltriethoxysilane and n-octyltriethoxysilane.

Advantageously, in the process according to the invention, components A and B are used in a molar ratio of 1:0 to 1:7, for example 10:1 to 1:6, especially 9:1, 8:1, 7:1, 6:1, 5:1, 4:1, 3:1, 2:1, 1:1, 1:2, 1:3, 1:4, 1:5—to name just a few advantageous use ratios.

In general, the process according to the invention is executed as follows:

In general, component(s) A and optionally component B are initially charged. It is also possible to use a mixture of the components in question as the charge. In addition, it is alternatively possible to charge one or both components at least in part and hydrolyse them, preferably partially hydrolyse them, and then to add the remaining amounts of the other component(s) and to continue the hydrolysis. The present alkoxysilane mixture is thus advantageously diluted with addition of 0.1 to 0.5 times the weight, preferably 0.11 to 0.3 times the weight, of methanol and/or ethanol, based on the alkoxysilanes used, over a period of up to about 30 minutes. The quantity of alcohol metered in may be aqueous, and the reaction mixture is advantageously mixed. In addition, any quantity of water which is still absent and is part of the quantity calculated for the reaction is metered in, suitably with good mixing, for example while stirring, and likewise over a period of up to about 30 minutes. Thus, a sum total of advantageously 0.7 to 1.2 mol, preferably 0.75, 0.8, 0.85, 0.9, 0.95, 1.0, 1.05, 1.1, 1.15 mol—to name just a few of the intermediate values—of water is metered in per 1 mol of Si in the alkoxysilanes used. Advantageously, before and/or after the metered addition of alcohol, alcohol/water and/or water, the reaction mixture can be heated, preferably to 60 to 80° C., preferably 60, 62, 64, 66, 68, 70, 72, 74, 76, 78° C.—to name just a few of the intermediate values; the heating can also be effected stepwise or continuously. Subsequently, reaction is allowed to continue while mixing, suitably over a further period of 15 minutes to 5 hours, preferably over 2 to 4 hours. The reaction can alternatively be conducted in the presence of a hydrolysis and condensation catalyst, for example an addition of conc. HCl or aqueous hydrochloric acid or sulphuric acid, to name just a few suitable catalysts, preferably in an amount of 0% to 0.5%, preferably 0.01% to 0.3%, more preferably 0.05% to 0.2% and especially 0.1% by weight of HCl, based on the amount of component(s) A or A and optionally B, i.e. A and B. The catalyst can be added, for example, together with the diluent, the diluent/water mixture and/or the water. After the reaction, the product mixture thus obtained is worked up by distillation in a particularly gentle manner. This generally virtually fully removes the fraction of methanol and/or ethanol present. Preferably, the distillative workup of the product mixture is conducted at a bottom temperature up to 90° C., preferably at 50 to 85° C., more preferably at 60 to 80° C., at standard pressure, i.e. atmospheric pressure, or under reduced pressure, preferably at a pressure of 400 mbar falling down to 10 mbar.

Through the present mode of preparation, it is advantageously possible to produce inventive aminopropyl-functional alkoxysiloxane oligomer mixtures which, in the case of co-condensates, for example, have a random distribution or block distribution of [(R)₂Si(O—)_{2/2}] units of different functionality and terminal [—O_{1/2}Si(R)₃] units. In addition, an inventive mixture may alternatively contain branched siloxane oligomers having [(R)Si(O—)_{3/2}] units, i.e. siloxane oligomers containing, as well as what are called M and D structures, T structures as well.

The definition of M, D, T and Q structures refers generally to the number of bonded oxygens, as illustrated below for silyl units by way of example:

M=monofunctional units [—O_{1/2}Si(R)₃]
D=difunctional units [(R)₂Si(O—)_{2/2}]
T=trifunctional units [(R)Si(O—)_{3/2}]
Q=tetrafunctional units [Si(O—)_{4/2}]

Accordingly, in order to be able to give a clearer description of silicones and siloxanes or silane oligomers, it is also possible to use the M, D, T and Q structures rather than an idealized formulaic description. For the more precise nomenclature of the designation of such siloxane structures, reference may be made to Rompp Chemielexikon—entry heading: Silicones. For example, only dimers can be formed from structural units M, with M₂. The construction of chains requires compositions of structural units D and M, and trimers (M₂D), tetramers (M₂D₂) and so on up to linear oligomers with M₂Dₙ can be constructed. The formation of cyclic oligomers requires structural units D. In this way, for example, rings with D₃, D₄, D₅ or higher can be constructed. Branched and/or crosslinked structural elements, among which are also spiro compounds, are obtained when structural units T and/or Q are present together. Conceivable crosslinked structures may be present in the form of Tₙ (n≧4), DₙTₘ (m<<n), DₙTₘ (n>>m), D₃T₂, M₄Q, D₄Q and so on, to name just a few conceivable possibilities. Structural units M are also referred to as stoppers or transfer agents, while D units are termed chain formers or ring formers, and the T, and possibly also Q, units are referred to as network formers. Thus the use of tetraalkoxysilanes, because of the four hydrolysable groups, and ingress of water and/or moisture, can bring about structural units Q and hence the formation of a network (three-dimensionally crosslinked). In contrast, fully hydrolysed trialkoxysilanes may result in branches, i.e. T units [—Si(—O—)_{3/2}], in a structural element, for example MD₃TM₂ for an oligomer having a degree of oligomerization of n=7, and in these structural representations the respective functionalities on the free valencies of the silyloxy units are to be defined.

Further details on the nomenclature comprehension of M, D, T and Q structures, and also relevant methods of analysis, include the following:
“Strukturuntersuchungen von oligomeren und polymeren Siloxanen durch hochauflösende ²⁹Si-Kernresonanz” [Structural analyses of oligomeric and polymeric siloxanes by high-resolution ²⁹Si nuclear resonance], H. G. Horn, H. Ch. Marsmann, Die Makromolekulare Chemie 162 (1972), 255-267;
“Über die ¹H-, ¹³C- und ²⁹Si-NMR chemischen Verschiebungen einiger linearer, verzweigter und cyclischer Methyl-Siloxan-Verbindungen” [The ¹H, ¹³C and ²⁹Si NMR chemical shifts of certain linear, branched and cyclic methylsiloxane compounds], G. Engelhardt, H. Jancke; J. Organometal. Chem. 28 (1971), 293-300;
“Chapter 8—NMR spectroscopy of organosilicon compounds”, Elizabeth A. Williams, The Chemistry of Organic Silicon Compounds, 1989 John Wiley & Sons Ltd, 511-533.

The amount of M, D, T or Q structures is determined in general by a method known per se to the skilled person, preferably by means of ²⁹Si NMR.

The present process is particularly selective and gentle on the product, for production of the specific inventive mixtures of homo-condensed or co-condensed aminopropyl-functional alkoxysiloxane oligomers, as can be inferred in idealized form from the formulae I and II. Compared to a mixture consisting of monomeric aminoalkyltrialkoxysilanes, an inventive mixture of aminopropyl-functional alkoxysiloxanes contains a much lower level of volatile organic compounds (VOCs), which is additionally an advantageous feature in the case of application in adhesives and sealants in that they are environmentally friendly, and not least also from the point of view of occupational hygiene.

Thus, the specific inventive mixtures with their advantageous use properties are obtainable by the process according to the invention with its selected measures.

The present invention likewise provides for the use of an inventive mixture in adhesives and/or in sealants, i.e. especially in corresponding moisture-curing sealant and adhesive compositions.

It is advantageous to use inventive mixtures in adhesive and sealant compositions, preferably for bonds of wood, glass, metals, plastics, painted surfaces and/or mineral substrates, especially for bonds of metal parts and plastic parts, bonds of two or more plastic parts, bonds of wooden parts and plastic parts, bonds of glass parts and metal parts and/or plastic parts, bonds of mineral substrates and metal parts and/or plastic parts, most preferably bonds in which the metal used is aluminium and the plastic used is polyolefin, polycarbonate and/or poly(meth)acrylate, polyvinyl chloride, polycarbonate and/or polymethylmethacrylate.

It is also particularly advantageous to use such adhesive or sealant compositions for bonds indoors and outdoors, especially for applications in motor vehicle construction, container construction, appliance manufacture and shipbuilding, in the interior fitout of real estate, and in window and door construction, and it is likewise particularly advantageous to use them for bonds in the production of protective glazing, sandwich bonds, lighting covers, lamp holders, switch parts, control knobs, and in window construction.

Such adhesive and sealant compositions additionally have very good storage stability when stored with exclusion of moisture and, after application to the substrate to be bonded, cure under the influence of moisture. In general, air humidity is sufficient to bring about the crosslinking of the adhesives and sealants.

Said adhesives and sealants have very good processibility and can be processed in a simple manner. After application to the substrates, a skin is formed. At 23° C. and 50% relative air humidity, a skin typically forms within 1 to 200 minutes. The duration of through-curing depends on factors including the thickness of the adhesive bond desired. Typically, through-curing in a layer of 1 to 5 mm proceeds within 24 hours.

The bonds produced are also notable for outstanding mechanical properties and for excellent adhesion. Through-cured bonds typically have moduli of elasticity of 0.2 to 10 N/mm², and tensile strengths of 1 to 10 N/mm², elongations at break of 100% to 1000%, and Shore A hardnesses of 20 to 90.

Thus, the inventive mixtures are surprisingly found to be particularly advantageous in the improvement of adhesives and sealants.

### EXAMPLES

In the use examples which follow, silane-modified polyurethane (ST61 and ST75 from Evonik Hanse GmbH) and a silane-modified polyether (MS polymer S303H from Kaneka Corp.) were used. ST61 was developed for high-modulus applications and had a dynamic viscosity of 35 000 mPas (at 25° C.). This was an aliphatic polyurethane which was clear and colourless.

### Example 1A

### Synthesis of an Aminopropyl-Functional Methoxysiloxane Oligomer

### Oligomer 1

A 2 l stirred glass reactor with vacuum, metered addition and distillation equipment was initially charged with 716 g of 3-aminopropyltrimethoxysilane (Dynasylan® AMMO) and 108 g of methanol. The metering apparatus was used to add a mixture of 72 g of water and 80 g of methanol dropwise within 10-30 minutes, in the course of which the reaction mixture warmed up slightly. Subsequently, the mixture was heated to about 70° C. and stirred for 2 hours. After the alcohol had been distilled off under reduced pressure (bottom temperature 50-70° C., pressure 400 mbar falling to 10 mbar), 532 g of a clear, colourless to pale yellowish liquid (oligomer 1) were obtained.

This oligomer was used to produce a test formulation with the silane-terminated polyurethane adhesive ST 61. The ingredients are shown in the next table.

### Example 1B

### Production of the Adhesive Compositions

| Component | Reactants for STPU adhesive formulation | Mass [g] |
|---|---|---|
| a) | Polymer ST 61 | 365.5 |
| b) | phthalate plasticizer | 145.3 |
| c) | chalk coated with stearic acid | 444.5 |
| d) | AEROSIL ® R 202 | 30.4 |
| e) | Dynasylan ® VTMO | 14.3 |
| f) | amino-functional silane (Dynasylan ® | 11.23 |
| | AMMO as comparative example for | |
| | Example 1C) or siloxane (oligomer 1 | |
| | from Example 1A for Example 1C) | |
| g) | dibutyltin dineodecanoate | 0.61 |

In a planetary mixer, base polymer a) and plasticizer b) were mixed together for 5 minutes. Thereafter, the chalk c) was stirred into the mixture in portions within 10 minutes, and the mixture was homogenized for 40 minutes (evolution of heat). Subsequently, component d) was introduced in portions while stirring within 10 minutes and the mixture was mixed for a further 20 minutes. This preliminary mixture was then cooled to about 40° C. under reduced pressure (about 30 mbar) with reduced stirrer power. After addition of component e) and further mixing (15 minutes), the mixture was degassed at 30 mbar for 5 minutes to give what is called the masterbatch.

For each of the individual performance tests, 100 g of this masterbatch were mixed with 1.12 g of component f) and 0.06 g of component g) in a rotary mixer (SpeedMixer™) for 30 seconds. The ready-formulated adhesive was transferred into a cartridge. The performance tests were effected from the cartridge.

### Performance Testing (Test Methods)

The adhesive was tested in accordance with DIN EN ISO 527 and DIN EN 1465 (tear strength, elongation at break, lap shear strength).

### Example 1C

### Use of a Homooligomer Produced from 3-Aminopropyltrimethoxysilane for Improving Adhesion on Aluminium Surfaces

A siloxane oligomer formed from 3-aminopropyltrimethoxysilane was used, which was prepared with 1.0 mol of water/mole of silicon according to Example 1A (=oligomer 1). In the STPU adhesive formulation according to Example 1B, this led to an improved adhesion on the aluminium substrate of about 30% compared to the market standard Dynasylan® AMMO. Other important mechanical indices of the adhesive, such as tensile strength and elongation at break, were not adversely affected.

The 180° tensile shear strength of the aluminium/aluminium adhesive bond in the presence of oligomer 1 in the adhesive was 4.77 N/mm², whereas the comparative strength in the case of use of Dynasylan® AMMO in the adhesive was 3.71 N/mm².

### Examples 2A to 6A

In analogy to the procedure of Example 1A, further aminopropyl-functional siloxane oligomers were prepared. The materials used and the procedure are detailed in the table below.

| | | | | Addition | Reaction | | |
|---|---|---|---|---|---|---|---|
| | Oligomer | | | time | temperature, | Distillative | Yield |
| Example | No. | Initial charge | Addition | [min] | time | removal | [g] |
| 2A | 2 | 178.4 g iso- | 40 g | 5 | 70° C. | Bottoms: | 579.1 |
| | | butyltrimethoxy- | water, | | 4 h | 50-70° C. | |
| | | silane, 13.3 g | 40 g | | | Pressure: | |
| | | water, 0.72 g | methanol | | | 400 mbar | |
| | | HCl (conc.), 40 g | | | | (falling to | |
| | | methanol, 537.2 g | | | | 10 mbar) | |
| | | AMMO | | | | | |
| 3A | 3 | 716 g AMMO | 86.4 g | 10-30 | 70° C. | Bottoms: | 495.2 |
| | | 108 g methanol | water, | | 2 h | 50-70° C. | |
| | | | 80 g | | | Pressure: | |
| | | | methanol | | | 400 mbar | |
| | | | | | | (falling to | |
| | | | | | | 10 mbar) | |
| 4A | 4 | 178.4 g iso- | 13.3 g | 5 | 70° C. | Bottoms: | 289.0 |
| | | butyltrimeth- | water, | | 4 h | 50-70° C. | |
| | | oxysilane, 13.3 g | 20 g | | | Pressure: | |
| | | water, 0.72 g | methanol | | | 400 mbar | |
| | | HCl (conc.), 40 g | | | | (falling to | |
| | | methanol, | | | | 10 mbar) | |
| | | 179.0 g AMMO | | | | | |
| 5a | 5 | 889.6 g N- | 86.4 g | 10-30 | 70° C. | Bottoms: | 668.8 |
| | | aminoethyl-3- | water, | | 2 h | 50-70° C. | |
| | | aminopropyltri- | 80 g | | | Pressure: | |
| | | methoxysilane, | methanol | | | 400 mbar | |
| | | 132 g methanol | | | | (falling to | |
| | | | | | | 10 mbar) | |
| 6A | 6 | 178.4 g iso- | 13.3 g | rapid | 70° C. | Bottoms: | 332.7 |
| | | butyltrimeth- | water, | | 4 h | 50-70° C. | |
| | | oxysilane, | 20 g | | | Pressure: | |
| | | 13.32 g water, | methanol | | | 400 mbar | |
| | | 0.72 g HCl | | | | (falling to | |
| | | (conc.), 20 g | | | | 10 mbar) | |
| | | methanol, | | | | | |
| | | 222.4 g amino- | | | | | |
| | | ethyl-3- | | | | | |
| | | aminopropyltri- | | | | | |
| | | methoxysilane | | | | | |

These oligomers were used to produce test formulations with the silane-terminated polyurethane adhesive ST 61 in analogy to Example 1B. The ingredients are shown in the next table.

### Examples 2B to 6B

### Production of the Adhesive Compositions

| | Example No. | | | | |
|---|---|---|---|---|---|
| | 2B | 3B | 4B | 5B | 6B |
| | Mass | Mass | Mass | Mass | Mass |
| Reactants | [g] | [g] | [g] | [g] | [g] |
| Polymer ST61 | 365.5 | 365.5 | 365.5 | 365.5 | 365.5 |
| phthalate | 145.3 | 145.3 | 145.3 | 145.3 | 145.3 |
| plasticizer | | | | | |
| chalk coated | 444.4 | 444.5 | 444.5 | 444.5 | 444.5 |
| with stearic | | | | | |
| acid | | | | | |
| AEROSIL ® | 30.4 | 30.4 | 30.4 | 30.4 | 30.4 |
| R 202 | | | | | |
| Dynasylan ® | 14.3 | 14.3 | 14.3 | 14.3 | 14.3 |
| VTMO | | | | | |
| amino- | 11.23 | 11.23 | 11.23 | 11.23 | 11.23 |
| functional | (oligo- | (oligo- | (oligo- | (oligo- | (oligo- |
| silane | mer 2A) | mer 3A) | mer 4A) | mer 5A) | mer 6A) |
| dibutyltin | 0.61 | 0.61 | 0.61 | 0.61 | 0.61 |
| dineodeca- | | | | | |
| noate | | | | | |

The masterbatch and the ready-formulated adhesive of Examples 2B to 6B were produced as described in Example 1B. The performance tests were effected from the cartridge containing the particular adhesive formulations.

### Examples 2C to 6C

### Performance Experiments

In analogy to Example 1C, performance tests were conducted. The results are shown in the tables which follow.

| Example | Adhe- | Adhesion to Al or | Elongation at break on | Tensile strength on |
|---|---|---|---|---|
| No. | sive | PC or PMMA*⁾ | Al or PC or PMMA*⁾ | Al or PC or PMMA*⁾ |
| 2C | 2B | 20% improvement | 20% lower than | no change from |
| | | over AMMO (on Al) | AMMO (on Al) | AMMO (on Al) |
| 3C | 3B | 32% improvement | no change from | no change from |
| | | over AMMO (on PC) | AMMO (on PC) | AMMO (on PC) |
| 4C | 4B | 7% improvement | 25% improvement | 8% improvement |
| | | over AMMO (on PC) | over AMMO (on PC) | over AMMO (on PC) |
| 5C | 5B | 165% improvement | no change from | no change from |
| | | over AMMO (on PMMA) | AMMO (on PMMA) | AMMO (on PMMA) |
| 6C | 6B | 25% improvement | 7% improvement | no change from |
| | | over AMMO (on PMMA) | over AMMO (on PMMA) | AMMO (on PMMA) |

| | | 180° tensile | Elongation | Tensile |
|---|---|---|---|---|
| | | shear strength | at break | strength |
| | Adhesive/ | (inventive/in | (inventive/in | (inventive/in |
| Example | adhesive | the presence | the presence | the presence |
| No. | bond*⁾ | of AMMO) | of AMMO) | of AMMO) |
| 2C | 2B/Al/Al | 4.37 N/mm²/ | 200%/ | 3.34 N/mm²/ |
| | | 3.71 N/mm² | 172% | 3.16 N/mm² |
| 3C | 3B/PC/PC | 3.59 N/mm²/ | 157%/ | 3.56 N/mm²/ |
| | | 2.73 N/mm² | 172% | 3.16 N/mm² |
| 4C | 4B/PC/PC | 2.91 N/mm²/ | 215%/ | 3.41 N/mm²/ |
| | | 2.73 N/mm² | 172% | 3.16 N/mm² |
| 5C | 5B/PMMA/ | 3.29 N/mm²/ | not | not |
| | PMMA | 1.25 N/mm² | determined | determined |
| 6C | 6B/PMMA/ | 1.54 N/mm²/ | 183%/ | 3.23 N/mm²/ |
| | PMMA | 1.25 N/mm² | 172% | 3.16 N/mm² |

*⁾Al = aluminium; PC = polycarbonate; PMMA = polymethylmethacrylate

### Examples 7A to 17A

In addition, in analogy to the procedure of example 1A (cf. also Examples 2A to 6A), further inventive aminopropyl-functional siloxane oligomers (co-oligomers) were prepared; the underlying molar ratios of the respective alkoxysilanes used are listed in the table below.

| Example | Oligomer | Component | Component | Molar feedstock |
|---|---|---|---|---|
| No. | No. | A | B | ratio A:B |
| 7A | 7 | AMMO | OCTMO | 1:1 |
| 8A | 8 | AMMO | OCTMO | 3:1 |
| 9A | 9 | AMMO | IBTMO | 1:1 |
| 10A | 10 | AMMO | IBTMO | 3:1 |
| 11A | 11 | DAMO | OCTMO | 1:1 |
| 12A | 12 | DAMO | OCTMO | 3:1 |
| 13A | 13 | TRIAMO | OCTMO | 3:1 |
| 14A | 14 | DAMO | IBTMO | 1:1 |
| 15A | 15 | DAMO | IBTMO | 3:1 |
| 16A | 16 | DAMO | OCTMO | 1:6.5 |
| 17A | 17 | TRIAMO | OCTMO | 1:6.5 |

### Examples 7C to 10C

In further performance tests, in accordance with Example 1C, the bond strength of STPU adhesive formulations in PC/PC adhesive bonds was tested, these having been produced in analogy to Example 1B, in each case using, in place of oligomer 1, an oligomer from the series 7 to 10 and, for example, AMMO (monomer) as standard. The results are compiled in the following table:

| Example | Silane or | 180° tensile shear |
|---|---|---|
| No. | oligomer No. | strength [N/mm²] |
| Standard | AMMO | 2.73 |
| 7C | 7 | 3.36 |
| 8C | 8 | 3.18 |
| 9C | 4 | 3.07 |
| 10C | 5 | 3.48 |

### Examples 11C to 15C

In further performance tests, in accordance with Example 1C, the bond strength of STPU adhesive formulations in PMMA/PMMA adhesive bonds was tested, these having been produced in analogy to Example 1B, in each case using, in place of oligomer 1, an oligomer from the series 11 to 15 and, for example, AMMO (monomer) as standard. The results are compiled in the following table:

| Example | Silane or | 180° tensile shear |
|---|---|---|
| No. | oligomer No. | strength [N/mm²] |
| Standard | AMMO | 1.25 |
| 11C | 11 | 1.45 |
| 12C | 12 | 2.00 |
| 13C | 13 | 1.52 |
| 14C | 14 | 1.54 |
| 15C | 15 | 1.56 |

### Examples 16C and 17C

In further performance tests, in accordance with Example 10, the bond strength of STPU sealant formulations in PC/PC adhesive bonds was tested, these having been produced in accordance with Example 1B, in each case using an oligomer from the series 16 to 17 and, for comparison, an oligomer formed from AMMO and PTMO according to EP 0 997 469 A2 as standard; the composition of the STPU sealant formulations is listed in the table below; also compiled in the table that follows thereafter are the results of the performance tests relating thereto:

| Reactants for STPU sealant formulation | Mass [g] |
|---|---|
| Polymer ST 75 | 101.02 |
| phthalate plasticizer | 40.6 |
| chalk coated with stearic acid | 131.32 |
| Dynasylan ® VTMO | 4.2 |
| AMMO/PTMO oligomer as comparative | 2.8 |
| example or oligomer 16 or 17 | |
| dibutyltin dineodecanoate | 0.056 |

| Example | Oligomer | 180° tensile shear |
|---|---|---|
| No. | No. | strength [N/mm²] |
| Standard | AMMO/PTMO | 1.6 |
| | oligomer | |
| 16C | 16 | 2.2 |
| 17C | 17 | 2.2 |

### Examples 18C to 22C

In further performance tests, in accordance with Example 1C, the bond strength of MS adhesive formulations in PC/PC adhesive bonds was tested, these having been produced in accordance with Example 1B, in each case using an oligomer from the series 8, 9, 11, 12, 15 and, for comparison, AMMO (monomer) as standard; the composition of the MS adhesive formulations is listed in the table below; also compiled in the table that follows thereafter are the results of the performance tests relating thereto:

| Reactants for MS adhesive formulation | Mass [g] |
|---|---|
| MS polymer S303H | 65.1 |
| phthalate plasticizer | 47.3 |
| chalk coated with stearic acid | 124.98 |
| AEROSIL ® R 202 | 15.6 |
| Dynasylan ® VTMO | 2.6 |
| Dynasylan ® AMMO as comparative | 3.9 |
| example or oligomer | |
| dibutyltin dineodecanoate | 0.52 |

| Example | Silane or | 180° tensile shear |
|---|---|---|
| No. | oligomer No. | strength [N/mm²] |
| Standard | AMMO | 1.35 |
| 18C | 11 | 1.65 |
| 19C | 8 | 1.71 |
| 20C | 12 | 1.62 |
| 21C | 15 | 1.59 |
| 22C | 9 | 1.83 |

The present performance examples especially demonstrate the surprising advantageous use of inventive functional alkoxysiloxane oligomer mixtures, as can be inferred from Examples 1A to 17A.

1. A mixture comprising catenated aminopropyl-functional alkoxysiloxane oligomers of the general formula I and/or cyclic aminopropyl-functional alkoxysiloxane oligomers of the general formula II 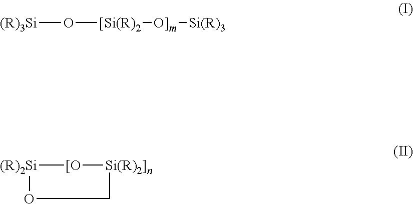
in which the R groups independently are
(i) aminopropyl-functional groups of the formulae
—(CH₂)₃—NH₂, —(CH₂)₃—NH(CH₂)₂—NH₂ and/or —(CH₂)₃—NH(CH₂)₂—NH(CH₂)₂—NH₂,
(ii) methoxy and/or ethoxy groups, and
(iii) optionally butyl or octyl groups,
m is an integer from 2 to 30 and n is an integer from 3 to 30, where not more than one aminopropyl-functional group is bonded to any silicon atom in a compound of the formula I or II, and where the molar ratio of Si to alkoxy groups is at least 0.3.

2. The mixture according to claim 1, wherein the individual R groups in the compounds of the formulae I and II are each independently selected from the group of 3-aminopropyl, N-(2-aminoethyl)-3-aminopropyl, N—[N′-(2-aminoethyl)-2-aminoethyl]-3-aminopropyl, methoxy, ethoxy, i-butyl, n-butyl, i-octyl, n-octyl radicals.

3. The mixture according to claim 1, wherein the individual R groups in the compounds of the formulae I and II are the radicals
3-aminopropyl and methoxy,
3-aminopropyl and ethoxy,
N-(2-aminoethyl)-3-aminopropyl and methoxy,
N-(2-aminoethyl)-3-aminopropyl and ethoxy,
N—[N′-(2-aminoethyl)-2-aminoethyl]-3-aminopropyl and methoxy,
N—[N′-(2-aminoethyl)-2-aminoethyl]-3-aminopropyl and ethoxy,
3-aminopropyl, i-butyl and methoxy,
3-aminopropyl, i-butyl and ethoxy,
N-(2-aminoethyl)-3-aminopropyl, i-butyl and methoxy,
N-(2-aminoethyl)-3-aminopropyl, i-butyl and ethoxy,
N—[N′-(2-aminoethyl)-2-aminoethyl]-3-aminopropyl, i-butyl and methoxy,
N—[N′-(2-aminoethyl)-2-aminoethyl]-3-aminopropyl, i-butyl and ethoxy,
3-aminopropyl, n-butyl and methoxy,
3-aminopropyl, n-butyl and ethoxy,
N-(2-aminoethyl)-3-aminopropyl, n-butyl and methoxy,
N-(2-aminoethyl)-3-aminopropyl, n-butyl and ethoxy,
N—[N′-(2-aminoethyl)-2-aminoethyl]-3-aminopropyl, n-butyl and methoxy,
N—[N′-(2-aminoethyl)-2-aminoethyl]-3-aminopropyl, n-butyl and ethoxy,
3-aminopropyl, i-octyl and methoxy,
3-aminopropyl, i-octyl and ethoxy,
N-(2-aminoethyl)-3-aminopropyl, i-octyl and methoxy,
N-(2-aminoethyl)-3-aminopropyl, i-octyl and ethoxy,
N—[N′-(2-aminoethyl)-2-aminoethyl]-3-aminopropyl, i-octyl and methoxy,
N—[N′-(2-aminoethyl)-2-aminoethyl]-3-aminopropyl, i-octyl and ethoxy,
3-aminopropyl, n-octyl and methoxy,
3-aminopropyl, n-octyl and ethoxy,
N-(2-aminoethyl)-3-aminopropyl, n-octyl and methoxy,
N-(2-aminoethyl)-3-aminopropyl, n-octyl and ethoxy,
N—[N′-(2-aminoethyl)-2-aminoethyl]-3-aminopropyl, n-octyl and methoxy,
or
N—[N′-(2-aminoethyl)-2-aminoethyl]-3-aminopropyl, n-octyl and ethoxy.

4. The mixture according to claim 1, which has a boiling point at pressure 1 atm of greater than 200° C.

5. The mixture according to claim 1, which has a flashpoint of greater than 100° C.

6. The mixture according to claim 1, wherein the aminoalkyl-functional siloxane oligomers are a mixture based essentially on catenated siloxanes and/or branched siloxanes of the general formulae I and II, where the content of alkoxy groups is between 0.1% and 70% by weight, and the content of free alcohol in the mixture is <5% by weight, based on the weight of the siloxane oligomer mixture.

7. A process for producing a mixture according to claim 1,
comprising subjecting components A and optionally B, successively or in a mixture, to controlled hydrolysis and condensation or co-condensation at a temperature of 60 to 80° C., optionally in the presence of a hydrolysis or condensation catalyst, in the presence of 0.7 to 1.2 mol of water per 1 mol of Si and 0.1 to 0.5 times the weight of, as an alcohol, methanol and/or ethanol, based on the weight of component A, and
subsequently removing alcohol from the product mixture by distillation at standard pressure or under reduced pressure and a bottom temperature up to 90° C.,
wherein component A is at least one 3-aminopropyl-functional trialkoxysilane, at least one N-(2-aminoethyl)-3-aminopropyl-functional trialkoxysilane and/or at least one N-[N′-(2-aminoethyl)-2-aminoethyl]-3-aminopropyltrialkoxysilane, and component B is at least one of a butyltrialkoxysilane and an octyltrialkoxysilane, wherein alkoxy is methoxy or ethoxy.

8. The process according to claim 7, wherein
components A, or A and B, are
3-aminopropyltrimethoxysilane,
3-aminopropyltriethoxysilane,
N-(2-aminoethyl)-3-aminopropyltrimethoxysilane,
N-(2-aminoethyl)-3-aminopropyltriethoxysilane,
N—[N′-(2-aminoethyl)-2-aminoethyl]-3-aminopropyltrimethoxysilane,
N—[N′-(2-aminoethyl)-2-aminoethyl]-3-aminopropyltriethoxysilane,
3-aminopropyltrimethoxysilane and i-butyltrimethoxysilane,
3-aminopropyltriethoxysilane and i-butyltriethoxysilane,
N-(2-aminoethyl)-3-aminopropyltrimethoxysilane and i-butyltrimethoxysilane,
N-(2-aminoethyl)-3-aminopropyltriethoxysilane and i-butyltriethoxysilane,
N—[N′-(2-aminoethyl)-2-aminoethyl]-3-aminopropyltrimethoxysilane and i-butyltrimethoxysilane,
N—[N′-(2-aminoethyl)-2-aminoethyl]-3-aminopropyltriethoxysilane and i-butyltriethoxysilane,
3-aminopropyltrimethoxysilane and n-butyltrimethoxysilane,
3-aminopropyltriethoxysilane and n-butyltriethoxysilane,
N-(2-aminoethyl)-3-aminopropyltrimethoxysilane and n-butyltrimethoxysilane,
N-(2-aminoethyl)-3-aminopropyltriethoxysilane and n-butyltriethoxysilane,
N—[N′-(2-aminoethyl)-2-aminoethyl]-3-aminopropyltrimethoxysilane and n-butyltrimethoxysilane,
N—[N′-(2-aminoethyl)-2-aminoethyl]-3-aminopropyltriethoxysilane and n-butyltriethoxysilane,
3-aminopropyltrimethoxysilane and i-octyltrimethoxysilane,
3-aminopropyltriethoxysilane and i-octyltriethoxysilane,
N-(2-aminoethyl)-3-aminopropyltrimethoxysilane and i-octyltrimethoxysilane,
N-(2-aminoethyl)-3-aminopropyltriethoxysilane and i-octyltriethoxysilane,
N—[N′-(2-aminoethyl)-2-aminoethyl]-3-aminopropyltrimethoxysilane and i-octyltrimethoxysilane,
N—[N′-(2-aminoethyl)-2-aminoethyl]-3-aminopropyltriethoxysilane and i-octyltriethoxysilane,
3-aminopropyltrimethoxysilane and n-octyltrimethoxysilane,
3-aminopropyltriethoxysilane and n-octyltriethoxysilane,
N-(2-aminoethyl)-3-aminopropyltrimethoxysilane and n-octyltrimethoxysilane,
N-(2-aminoethyl)-3-aminopropyltriethoxysilane and n-octyltriethoxysilane,
N—[N′-(2-aminoethyl)-2-aminoethyl]-3-aminopropyltrimethoxysilane and n-octyltrimethoxysilane
or
N—[N′-(2-aminoethyl)-2-aminoethyl]-3-aminopropyltriethoxysilane and n-octyltriethoxysilane.

9. The process according to claim 7, wherein components A and B are in a molar ratio of 1:0 to 1:7.

10. The process according to claim 7, wherein the hydrolysis and condensation catalyst is present and is hydrogen chloride (HCl).

11. The mixture according to claim 1, which is obtained by a process comprising subjecting components A and optionally B, successively or in a mixture, to controlled hydrolysis and condensation or co-condensation at a temperature of 60 to 80° C., optionally in the presence of a hydrolysis or condensation catalyst, in the presence of 0.7 to 1.2 mol of water per 1 mol of Si and 0.1 to 0.5 times the weight of, as an alcohol, methanol and/or ethanol, based on the weight of component A, and
subsequently removing alcohol from the product mixture by distillation at standard pressure or under reduced pressure and a bottom temperature up to 90° C.,
wherein component A is at least one 3-aminopropyl-functional trialkoxysilane, at least one N-(2-aminoethyl)-3-aminopropyl-functional trialkoxysilane and/or at least one N-[N′-(2-aminoethyl)-2-aminoethyl]-3-aminopropyltrialkoxysilane, and component B is at least one of a butyltrialkoxysilane and a octyltrialkoxysilane, wherein alkoxy is methoxy or ethoxy.

12. An adhesive or sealant comprising the mixture according to claim 1.

13-15. (canceled)

16. The mixture according to claim 6, wherein the content of alkoxy groups is 0.5% to 60% by weight and the content of free alcohol in the mixture is 0.001% to 3% by weight, based on the weight of the siloxane oligomer mixture.

17. The mixture according to claim 6, wherein the content of alkoxy groups is 5% to 50% by weight and the content of free alcohol in the mixture is 0.01% to 1% by weight, based on the weight of the siloxane oligomer mixture.

18. The process according to claim 10, wherein the HCl in present in an amount of up to 0.5% by weight, based on the amount of components A and optionally B.
